(19) United States
(12) Patent Application Publication
(10) Pub. No.: US 2004/0253044 A1
(43) Pub. Date: Dec. 16, 2004

(54) Container for storing and applying a liquid deodorant

(75) Inventor: Renato Miranda, Sao Paulo (BR)

Correspondence Address: DARBY & DARBY P.C., P. O. BOX 5257, NEW YORK, NY, 10150-5257, US

(73) Assignee: Globalpack Industria E. Comercio Ltda., Sao Paulo - SP (BR)

(21) Appl. No.: 10/825,619

(22) Filed: Apr. 15, 2004

(30) Foreign Application Priority Data
Apr. 17, 2003 (BR) MU 8300554-4

(51) Int. Cl. B43K 7/03; B43K 7/00; G02B 6/36

(52) U.S. Cl. 401/209

(57) ABSTRACT

A container for storing and applying a liquid deodorant, comprising a tubular body (10) provided with an end nozzle (11) retaining a free rotating sphere (20), and a tubular cap (30) to be fitted to the tubular body (10), in order to cover the end nozzle (11), and presenting an end wall (31) that defines a seating surface for the container in an inverted position, with the end nozzle (11) facing downwardly. The end wall (31) of the cap (30) defines, internally, a concave cradle (32) in the form of a spherical calotte, inside which a corresponding portion of the sphere (20) is seated when the cap (30) is fitted to the tubular body (10).

### FIELD OF THE INVENTION

The present invention refers to a container that is shaped to allow storing a load of liquid deodorant and applying the latter to the user's body through the roll-on system.

### BACKGROUND OF THE INVENTION

There are well known from the prior art the containers for storing and applying a liquid deodorant of the roll-on type and which comprise a tubular body, defining the element to be manually grasped by the user and presenting an end nozzle, in the form of a spherical annular bearing, in which a generally hollow sphere is retained, free rotating and projecting partially outwardly from the tubular body and maintaining a portion of its surface turned to the interior of the body, so as to be wetted by the load of liquid deodorant stored therein.

The rotation of the sphere, by contacting the user's body during the displacement of the container, allows the sphere surface portion, which is wetted by the liquid deodorant, to contact the user's skin, transferring to the latter the liquid deodorant aggregated to the sphere inside the tubular body.

While being very practical and of simple construction, this type of container for storing and applying a liquid deodorant has an inconvenience that becomes enhanced as the load of deodorant is being consumed. Generally, when the load of the liquid deodorant is reduced to about half the original volume, the user has to shake the container before using it, so that the liquid load reaches the sphere surface portion turned to the interior of the container, wetting said sphere surface portion and allowing the liquid load to be transferred to the user's body upon rotating the sphere.

In these known roll-on constructions, when the load of the liquid deodorant is reduced inside the container, its transfer to the sphere does not occur with the normal movement the user applies to the tubular body when the latter is grasped in its inoperative rest position, seated on its bottom and with the sphere turned upwardly. To make the liquid wet the sphere, the user has to shake the stored product, otherwise he/she will not be able to obtain the necessary transfer of the deodorant to the sphere surface portion turned to the inside of the container.

Aiming at eliminating the deficiency cited above in relation to the prior art roll-on containers, a constructive solution is proposed in Patent Application MU 8002322-3, filed in the name of an applicant associated with the applicant of the present invention and developed by the same inventor. In said prior art constructive solution, the tubular body of the container is provided with a tubular cap covering the end nozzle and incorporating an end wall that defines a surface onto which the tubular body is seated in an inverted position, with the end nozzle facing downwardly. The tubular body of the container has a bottom wall that is preferably shaped to avoid the definition of a seating surface for the container. This prior art construction, developed by the same inventor of the present invention, allows the sphere to remain constantly in contact with the liquid load stored in the container. However, to prevent the sphere from rotating under the weight of the liquid load when the container is in the inverted rest position, the cap has its end wall incorporating, internally, a cradle defined by a tubular projection with a diameter smaller than that of the sphere and onto whose annular end edge is seated the sphere when the cap is applied to the tubular body of the container.

In this constructive arrangement disclosed by MU 8002322-3, when the container is taken to the rest condition, the sphere is seated on the internal cradle of the cap along an annular alignment of reduced width and corresponding approximately to the wall width of the tubular cradle. To maintain its surface with no deformations caused upon seating on the edge of the tubular cradle, the sphere needs to have a strong construction with a considerable wall thickness. It should be noted that even small deformations or dents on the surface of the sphere can impair the tightness when said sphere is rotatably seated on the spherical annular bearing.

Thus, while said prior art constructive arrangement leads to a better and more comfortable operation of the container for storing and applying a deodorant, it requires the provision of spheres with relatively thick walls, consuming a relevant amount of material, consequently increasing costs and resulting in a strong and heavy component, whose rotation on the spherical annular bearing requires more intense contact with the user's body.

### OBJECTS OF THE INVENTION

It is the object of the present invention to provide a container of the type described in Patent Application MU 8002322-3, which allows the sphere to be constructed with a substantially reduced wall thickness and consequently with less material and less weight, with no risk of being superficially deformed when seated on the corresponding cradle provided in the interior of the cap.

### SUMMARY OF THE INVENTION

The container for storing an applying a liquid deodorant of the present invention is of the type comprising a tubular body provided with an end nozzle, in the form of a spherical annular bearing, retaining a sphere, free rotating and projecting partially outwardly from the tubular body; and a tubular cap to be fitted to the tubular body, so as to cover the end nozzle and presenting an end wall that defines a seating surface for the container in an inverted position, with the end nozzle facing downwardly.

According to the invention, the end wall of the cap defines, internally, a concave cradle, in the form of a spherical calotte, inside which a corresponding sphere portion is seated, when the cap is fitted to the tubular body.

With the construction above, the sphere has a great part of its surface, which is projected outwardly from the tubular body, seated in the interior of the cradle, allowing the sphere to be produced with a wall of reduced thickness, with no risk of having its surface deformed or marked by the cradle.

### BRIEF DESCRIPTION OF THE DRAWINGS

The invention will be described below, with reference to the appended drawings, given by way of example of an embodiment of the present container and in which:

FIG. 1 is an exploded perspective view of the present container;

FIG. 2 is a diametrical vertical sectional view of the container with the cap already fitted to the tubular body;

FIG. 3 is a diametrical vertical sectional perspective view of the container with the cap; and

FIG. 4 is a diametrical sectional view of the cap.

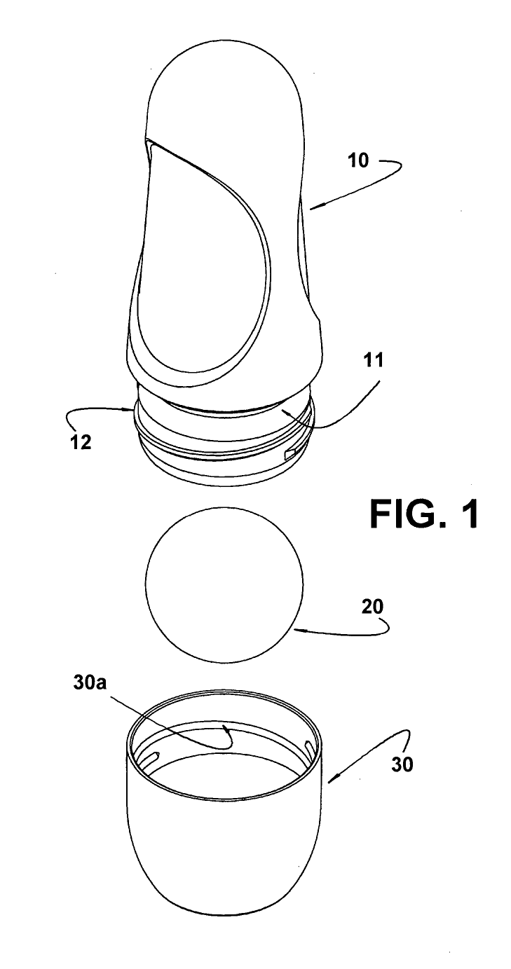

### DESCRIPTION OF THE ILLUSTRATED EMBODIMENT

As illustrated, the container of the present invention comprises a tubular body 10, made of plastic or any other material and having a substantially cylindrical contour, or any other cross section, provided with an end nozzle 11 in the form of a spherical annular bearing, inside which is tightly retained a sphere 20, free rotating and projecting partially outwardly form the tubular body 10.

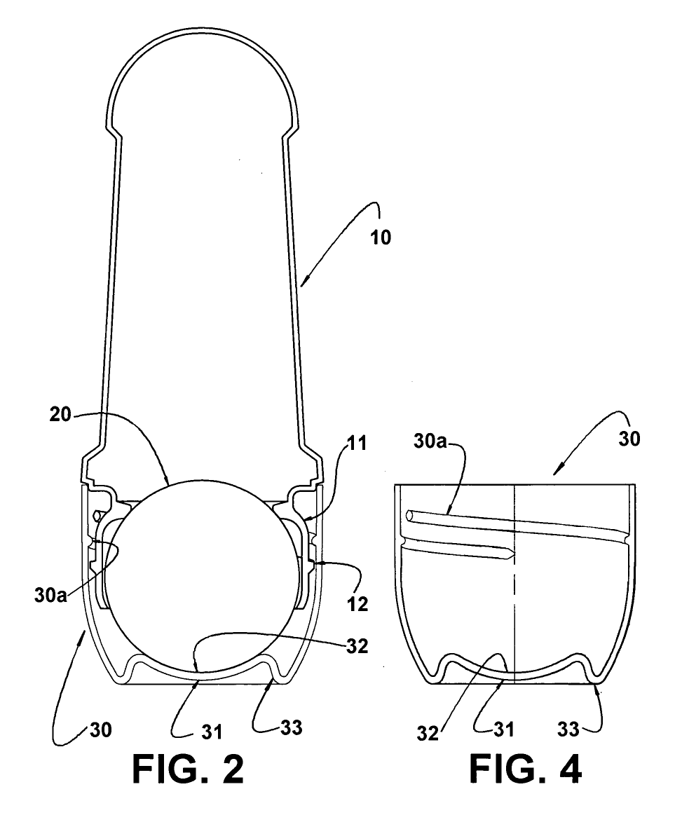

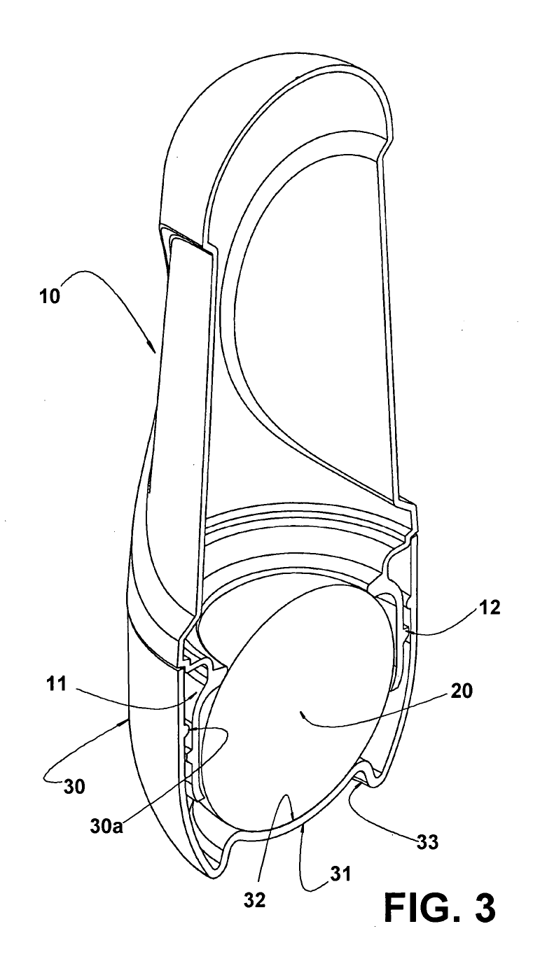

The end nozzle 11 may be formed in a single piece with the container, defining the spherical annular bearing, such as illustrated in FIGS. 2 and 3, or it may include an insert mounted into the respective opening of the container, so as to define in the latter the spherical annular bearing.

The tubular body 10 can incorporate a screw thread 12, which is disposed external and close to the end nozzle 11 or directly onto the latter, in order to receive and retain a cap 30, of tubular shape and which in this case is provided with an internal thread 30a. It should be understood that the fitting of the cap 30 to the tubular body 10 could be made by other manners that do not require the provision of threads.

According to the invention, the cap 30 presents an end wall 31 which is shaped to define a seating surface for the container in an inverted position, with the end nozzle 11 turned downwardly, allowing the liquid deodorant stored in the container to remain in contact with the sphere 20.

According to the invention, the end wall 31 of the cap 30 defines, internally, a concave cradle 32 in the form of a spherical calotte, inside which is seated a corresponding portion of the sphere 20, upon fitting the cap 30 to the tubular body 10. In the illustrated construction, the concave cradle 32 is defined by a corresponding median deformation of the end wall 31 of the cap 30, making the seating surface of the container be defined by a peripheral annular portion 33 of the end wall 31.

It should be understood that the tubular body 10, the end nozzle 11, and the cap 20 could present different shapes, without departing from the constructive arrangement defined in the claims that accompany the specification described herein.

1. A container for storing and applying a liquid deodorant, comprising a tubular body (10) provided with an end nozzle (11) in the form of a spherical annular bearing retaining a sphere (20), free rotating and projecting partially outwardly from the tubular body (10), and a tubular cap (30) to be fitted to the tubular body (10), in order to cover the end nozzle (11), and presenting an end wall (31) that defines a seating surface for the container in an inverted position, with the end nozzle (11) facing downwardly, characterized in that the end wall (31) of the cap (30) defines, internally, a concave cradle (32) in the form of a spherical calotte, inside which a corresponding portion of the sphere (20) is seated when the cap (30) is fitted to the tubular body (10).

2. The container as set forth in claim 1, characterized in that the concave cradle (32) is defined by a corresponding median deformation of the end wall (31) of the cap (30).

3. The container as set forth in claim 2, characterized in that the seating surface of the container is defined by a peripheral annular portion (33) of the end wall (31) of the cap (30).
